(19) United States
(12) Patent Application Publication
(10) Pub. No.: US 2026/0207436 A1
(43) Pub. Date: Jul. 23, 2026

(54) ARTIFICIAL NIPPLE

(71) Applicant: Northeast Ohio Medical University, Rootstown, OH (US)

(72) Inventors: C.J. MAYERL, Rootstown, OH (US); R.Z. GERMAN, Rootstown, OH (US)

(21) Appl. No.: 19/137,747

(22) PCT Filed: Dec. 12, 2023
(86) PCT No.: PCT/US2023/083683

§ 371 Date: Jun. 11, 2025

Related U.S. Application Data
(60) Provisional application No. 63/431,776, filed on Dec. 12, 2022.

(51) Int. Cl. A61J 11/00; A61J 11/04

(52) U.S. Cl. CPC A61J 11/0065; A61J 11/04

(57) ABSTRACT

An artificial nipple includes a nipple body and a network. The nipple body has a base portion and a mouth portion extending longitudinally from the base portion. The nipple body has a proximal end surface at the base portion and an oppositely disposed distal end surface at the mouth portion. The network includes a plurality of fluid passageways extending between a plurality of inlet openings located at or adjacent to the proximal end surface and a single outlet opening located at or adjacent to the distal end surface.

### RELATED APPLICATION

This application is a National Stage application and claims priority to PCT international application PCT/US2023/083683, filed on Dec. 12, 2023 entitled “ARTIFICIAL NIPPLE”, which claims the priority of U.S. Provisional Patent Application No. 63/431,776 filed Dec. 12, 2022, both of which are incorporated herein by reference in their entireties.

### GOVERNMENT FUNDING

This invention was made with government support under HD105294 awarded by the National Institutes of Health. The government has certain rights in the invention.

### TECHNICAL FIELD

This disclosure relates to an artificial nipple. This disclosure also relates to a nursing bottle comprising a container and an artificial nipple secured to the container.

### BACKGROUND

Infant feeding is a complex behavior that requires the ability to both acquire milk, as well as transport and swallow it. Understanding the mechanisms behind these tasks can be difficult due to the complexity of infant feeding as well as the fragile nature of infants, especially medically compromised infants. There are many commercially available artificial nipples, yet most (if not all) of them are designed as a cistern filled with milk, without a system of ducts, emptying directly into the infant's mouth from the artificial nipple. This system is found in cows, but the human breast is comprised of a series of ducts that release milk from multiple glands within the breast. Because of this, the mechanics of breast and bottle feeding differ, and infants often struggle when being introduced to the breast, or conversely, refuse a bottle after exclusive breastfeeding.

### SUMMARY

In an aspect, alone or in combination with any other aspect, an artificial nipple is provided. The artificial nipple can comprise a nipple body. The nipple body can have a base portion and a mouth portion extending longitudinally from the base portion. The nipple body can have a proximal end surface at the base portion and an oppositely disposed distal end surface at the mouth portion. The artificial nipple can also comprise a network. The network can comprise a plurality of fluid passageways extending between a plurality of inlet openings located at the proximal end surface and a single outlet opening located at the distal end surface.

In an aspect, alone or in combination with any other aspect, an artificial nipple is provided. The artificial nipple can comprise a substantially solid nipple body. The nipple body can have a base portion and a mouth portion extending longitudinally from the base portion. The nipple body can have a proximal end surface at the base portion and an oppositely disposed distal end surface at the mouth portion. A plurality of fluid passageways can each extend longitudinally from an inlet opening located at the proximal end surface to an outlet opening located at the distal end surface.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1a is an exploded side view of a nursing bottle according to one aspect of the present disclosure;

FIG. 1b is a perspective side view of the nursing bottle of FIG. 1a in an assembled state;

FIG. 2 is a cross-sectional view taken along Line 2-2 in FIG. 1b showing a portion of the nursing bottle of FIGS. 1a-b, including an artificial nipple of the nursing bottle in a first configuration;

FIG. 3 is a top side view of the artificial nipple of FIG. 2;

FIG. 4 depicts example performance-based test results of a cisternic artificial nipple and the artificial nipple of FIG. 2;

FIG. 5 is a cross-sectional view showing an alternative configuration of the nursing bottle in FIG. 2;

FIG. 6 is a cross-sectional view showing another alternative configuration of the nursing bottle in FIG. 2;

FIG. 7 is a schematic illustration of a network of an artificial nipple constructed in accordance with another aspect of the present disclosure;

FIG. 8 is a perspective view of the artificial nipple of FIG. 7;

FIG. 9 is a bottom side view of the artificial nipple of FIG. 8;

FIG. 10 is a schematic illustration of another network of an artificial nipple constructed in accordance with another aspect of the present disclosure;

FIG. 11 is a top side view of the network of FIG. 10;

FIG. 12 is a bottom side view of the network of FIG. 10;

FIG. 13 is a side view of the artificial nipple constructed having the network of FIG. 10;

FIG. 14 is a side view showing a nursing bottle having the artificial nipple of FIG. 13;

FIG. 15 is a side view showing a nursing bottle having an alternate configuration of the artificial nipple of FIG. 13;

FIG. 16 is a schematic illustration of an example network molding structure used to construct the artificial nipple of FIG. 15;

FIG. 17 is a graph showing growth and efficiency-based test results of a cisternic artificial nipple and the artificial nipple of FIG. 5; demonstrating that when fed ad libitum, infants raised on a ducted nipple are able to reach a higher mass than those raised on a cisternic nipple;

FIG. 18 is a graph showing behavioral rates of feeding-based test results of a cisternic artificial nipple and the artificial nipple of FIG. 5; demonstrating that infants raised on a cisternic nipple feeding on a ducted nipple suck and swallow at a different rate than those raised on a ducted nipple, or those raised on a cisternic nipple feeding on a ducted nipple;

FIG. 19 is a graph showing the physiology of feeding-based test results of a cisternic artificial nipple and the artificial nipple of FIG. 5; demonstrating that infants raised on a cisternic nipple at 21 days of age (approximately an 8 month human) are less able to feed on a ducted nipple than on a cisternic nipple, and are less able to acquire milk than infants raised on a ducted nipple, and that infants raised on a ducted nipple are less likely to experience aspiration than those raised on a cisternic nipple, especially when feeding on a ducted nipple;

FIG. 20 is a graph showing that pigs raised on cisternic nipples generally performed a full latch later than pigs raised on ducted nipples (such as the artificial nipple of FIG. 13);

FIG. 21 is a graph showing that pigs raised on cisternic nipples generated less intraoral suction than pigs raised on ducted nipples (such as the artificial nipple of FIG. 13) throughout ontogeny (p<0.0001; cohen's d>1), that pigs raised on the ducted nipples achieved greater intraoral suction earlier in ontogeny than pigs raised on cisternic nipples, and that at 28 days old, both groups of pigs generated similar intraoral suction;

FIG. 22 is a graph showing that pigs raised on cisternic nipples consumed milk faster than pigs raised on ducted nipples (such as the artificial nipple of FIG. 13) throughout ontogeny (p<0.005), and that pigs raised on cisternic nipples increased their feeding rate through ontogeny faster than pigs raised on ducted nipples (p<0.0001);

FIG. 23 is a graph showing that at 28 days old, pigs feeding on cisternic nipples compressed the nipple more than pigs feeding on ducted nipples (such as the artificial nipple of FIG. 13) (p<000.1, cohen's d>1), and that pigs raised on cisternic nipples compressed the nipple more than pigs raised on ducted nipples (p<000.1, cohen's d>0.8);

FIG. 24 is a graph showing that at 28 days old, all pigs generated intraoral suction (p>0.05) regardless of the nipple type they were raised on or feeding on; and

FIG. 25 is a graph showing that at 28 days old, pigs feeding on cisternic nipples consumed milk faster than pigs feeding on ducted nipples (such as the artificial nipple of FIG. 13) (p<0.0001, cohen's d>0.9).

### DETAILED DESCRIPTION

Unless defined otherwise, all technical and scientific terms used herein have the same meaning as is commonly understood by one of ordinary skill in the art to which the present disclosure pertains.

As used herein, the term “subject” can refer to any mammal (e.g., human beings, monkeys, apes, dogs, cats, pig, farm animals, and livestock).

As used herein, the singular forms “a,” “an” and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

As used herein, phrases such as “between X and Y” can be interpreted to include X and Y.

It will be understood that when an element is referred to as being “on,” “connected” to, “contacting,” etc., another element, it can be directly on, connected to or contacting the other element or intervening elements may also be present. In contrast, when an element is referred to as being, for example, “directly contacting” another element, there are no intervening elements present. It will also be appreciated by those of skill in the art that references to a structure or feature that is disposed “adjacent” another feature may not have portions that overlap or underlie the adjacent feature.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or Figures unless specifically indicated otherwise.

A “predetermined” status may be determined at any time before the structures being manipulated actually reach that status, the “predetermination” being made as late as immediately before the structure achieves the predetermined status.

The term “substantially” is used herein to indicate a quality that is largely, but not necessarily wholly, that which is specified—a “substantial” quality admits of the potential for some relatively minor deviation(s) from the quality.

It will be understood that two or more elements that are described as being in “fluid communication” with one another and/or “fluidically connected” to one another are arranged in such a manner that fluid may flow from directly one of the elements to at least one of the other elements as desired or in such a manner that fluid may flow from one of the elements through one or more intervening elements to at least one of the other elements. In contrast, two or more elements that are described as being in “direct fluid communication” with one another and/or “directly fluidically connected” to one another are arranged in such a manner that fluid may flow directly from one of the elements to at least one of the other elements as desired without flowing through any intervening elements.

The present disclosure comprises, consists of, or consists essentially of the following features, in any combination.

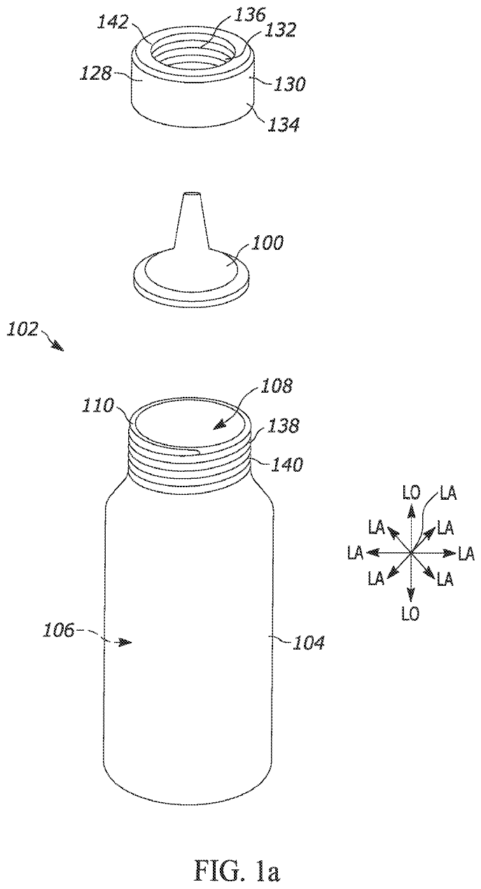

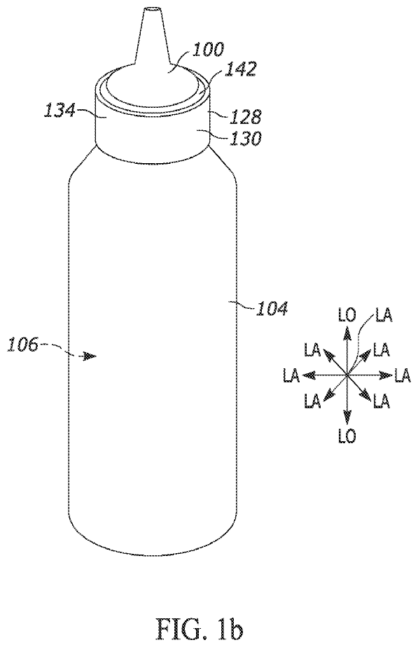

The present disclosure relates to an artificial nipple 100 (FIGS. 1a-b) that may form a part of a nursing bottle 102. FIGS. 1a-b depicts an exemplary configuration of the nursing bottle 102. As shown in FIGS. 1a-b, the nursing bottle 102 includes a container 104 having an interior cavity 106 and a container opening 108 in fluid communication with the interior cavity 106. The interior cavity 106 is configured to selectively hold a predetermined amount of fluid (e.g., a liquid such as milk, water, a therapeutic fluid (e.g., saline), any other desired liquid, or any combination thereof). The container 104 also includes a longitudinally facing container rim 110 that extends circumferentially around the container opening 108. The term “longitudinal” is used herein to indicate a vertical or substantially vertical direction, in the orientation of FIGS. 1a-b, and is shown at LO in FIGS. 1a-b.

The artificial nipple 100 is configured to be selectively secured to the container 104. The artificial nipple 100 is designed to better mimic the physiology and performance of breastfeeding infants than cisternic artificial nipples. Therefore, while cisternic artificial nipples are essentially hollow tubes that fill with milk, the artificial nipple 100 of the present disclosure is substantially solid with a plurality of fluid passageways (i.e., ducts) extending therethrough. The general perspective on infant feeding is that ‘breast is best’, from biomechanical and nutritional perspectives. However, not all mothers can or desire to breastfeed exclusively, and must instead use either a combination of breast and bottle feeding, or solely rely on bottles. When mothers attempt to introduce bottles after breastfeeding, or introduce the breast after bottle feeding, they often experience challenges in doing so due to the differences in nipple construction. The artificial nipple 100 is intended to ameliorate those challenges, by more accurately mimicking the material properties of the breast. Additionally, many known artificial nipples provide a feeding physiology more similar to drinking from a cup than breastfeeding, with lower electromyography (“EMG”) activity of the muscles of the neck and tongue, and potential downstream consequences. For example, infants that are breastfed have better speech-language outcomes than those that are bottle fed even at the age of five. Additionally, oxygen saturation levels, self-regulatory abilities, and swallow-breathe coordination are all thought to be better during breastfeeding than bottle feeding. The artificial nipple 100 is intended to reduce those disparities.

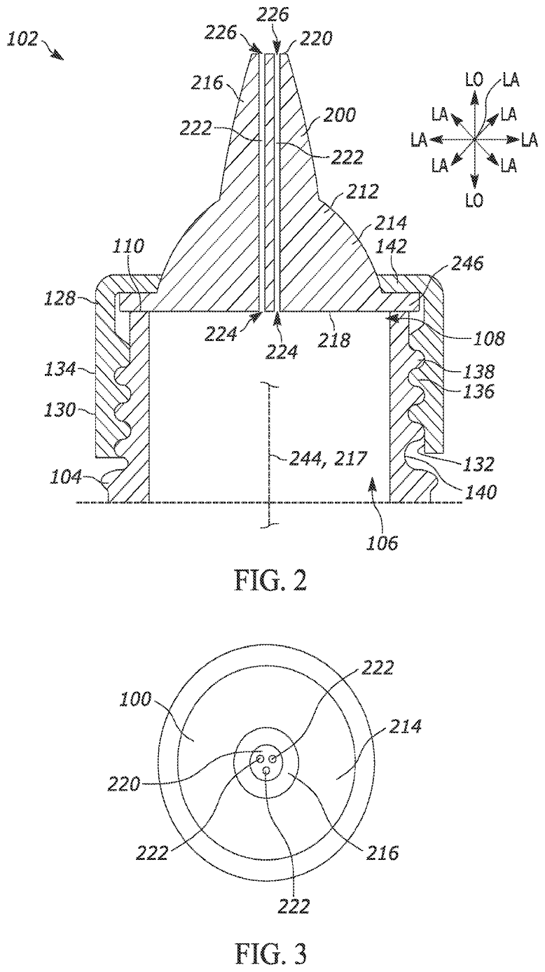

The artificial nipple 200 of FIG. 2 is an exemplary configuration of the artificial nipple 100 shown in FIGS. 1a-b, and is designed in accordance with the present disclosure. As shown in FIG. 2, the artificial nipple 200 includes a nipple body 212 having a base portion 214 and a mouth portion 216 extending longitudinally from the base portion 214 relative to a central longitudinal axis 217 of the artificial nipple 200. The base portion 214 is configured to be adjacent to the container 104, while the mouth portion 216 is configured to be at least partially inserted into a subject's oral cavity (e.g., a human infant's oral cavity). At least a portion of the subject's lips may rest against a portion of the base portion 214 during use of the artificial nipple 200. In such case, the base portion 214 may have a larger lateral diameter than the mouth portion 216. The term “lateral” is used herein to indicate a direction perpendicular or substantially perpendicular to the “longitudinal” direction, and is shown at LA in FIG. 2. As shown in the configuration of FIG. 2, the base portion 214 may have a substantially semi-hemispheric shape, while the mouth portion 216 may be substantially shaped as a truncated cone. The nipple body 212 also has a proximal end surface 218 at the base portion 214 and an oppositely disposed and longitudinally spaced distal end surface 220 at the mouth portion 216.

The artificial nipple 200 includes a plurality of fluid passageways 222. The artificial nipple 200 is shown in FIGS. 2-3 as having three fluid passageways 222, though the artificial nipple 200 may include two or more fluid passageways 222. Each fluid passageway 222 extends longitudinally from an inlet opening 224 located at the proximal end surface 218 to an outlet opening 226 located at the distal end surface 220 relative to the central longitudinal axis 217 of the artificial nipple 200.

As shown in FIG. 2, the nipple body 212 is substantially solid. By “substantially solid” it is meant that except for the inclusion of the fluid passageways 222, the nipple body 212 is solid from the proximal end surface 218 to the distal end surface 220. In other words, the nipple body 212 has a volume that is entirely solid other than a volume defined by each of the fluid passageways 222. As discussed above, the artificial nipple 200, being substantially solid and having a plurality of fluid passageways 222, more closely mimics the physiology and structure of a mammary gland (human or otherwise) than cisternic artificial nipples. Furthermore, the nipple body 212 may be formed from a material that mimics the biological properties of a mammary gland (human or otherwise) via an injection molding or any other suitable process. The material may be, for example, silicone (e.g., food-safe silicone rubber), any other suitable material, or any combination thereof.

In some instances, the shape of the nipple body 212 is based on the anatomy of a pig's mammary gland. In other instances, the shape of the nipple body 212 is based on the anatomy of the mammary gland of any other mammal (such as, e.g., a human mammary gland).

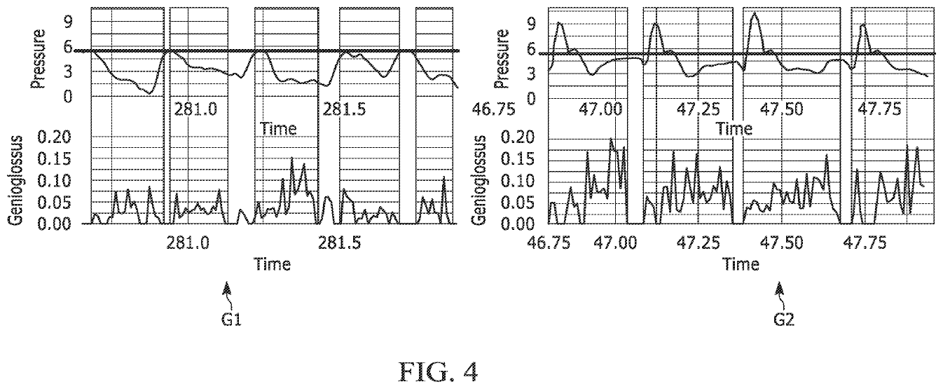

The artificial nipple 200 also more closely mimics the performance of breastfeeding infants than cisternic artificial nipples. For example, the first and second graphs G1, G2 of FIG. 4 show pressure and genioglossus test results of an artificial cisternic (first graph G1) compared to that of the artificial nipple (second graph G2). As shown in FIG. 4, pressure generation in the second graph G2 is almost double of that shown in the first graph G1, EMG activity in genioglossus is also much higher in the second graph G2 than in the first graph G1, and rhythmicity in pressure generation is better in the second graph G2 than in the first graph G1. These results are especially promising because breastfeeding infants generate more pressure and have higher EMG firing amplitudes than infants fed on cisternic artificial nipples.

As shown in FIGS. 1-2, the artificial nipple 200 may be selectively secured to the container via a collar 128. The collar 128 includes a collar base portion 130 having opposite inner and outer collar surfaces 132, 134. The inner collar surface 132 includes internal threads 136 that are configured to mate with external threads 138 on an outer surface 140 of the container 104 to secure the collar 128 to the container 104. As shown in FIGS. 1-2, the external threads 138 of the container 104 are positioned adjacent to the container opening 108.

The collar 128 also includes a collar flange 142 portion extending laterally inward toward a central longitudinal axis 244 of the nursing bottle 102 from the collar base portion 130. As shown in FIG. 2, the central longitudinal axis 217 of the artificial nipple 200 may be coaxial with the central longitudinal axis 244 of the nursing body, though these axes 244 may also be at least partially laterally offset from one another. When the artificial nipple 200 is secured to the container 104, an external flange 246 of the artificial nipple 200 is positioned longitudinally between the collar flange portion 142 and the container rim 110 and retained in such position via a compressive force. The external flange 246 may be a partial or fully annular flange that extends laterally outward away from the central longitudinal axis 244 from the base portion 214 of the artificial nipple 200. A portion of the external flange 246 and/or a portion of the base portion 214 may directly contact the container rim 110 when the artificial nipple 200 is secured to the container 104. Alternatively, a portion of the external flange 246 and/or a portion of the base portion 214 may directly contact an intermediate nursing bottle part, which may be separate from both the artificial nipple 200 and the container 104, positioned longitudinally between the container rim 110 and the artificial nipple 200.

The secured artificial nipple 200 is positioned such that the inlet openings 224 are axially aligned with the container opening 108 and fluidically connect the interior cavity 106 to the fluid passageways 222. Because of this arrangement, suckling by the subject draws fluid from the interior cavity 106 into the fluid passageways 222, through the fluid passageways 222, and out of the outlet openings 226 into the subject's oral cavity. Although the artificial nipple 100 is described as being secured and retained secured to the container 104 via the collar 128 and the compressive force, the artificial nipple 200 may be secured and/or retained secured to the container 104 in any other desired manner.

As shown in FIG. 2, each fluid passageway 222 extends linearly in the longitudinal direction such that the lateral diameters of the inlet opening 224, the fluid passageway 222, and the outlet opening 226 are all the same. Furthermore, the lateral diameter of each fluid passageway 222 is the same as each of the other fluid passageways 222. This is but one example configuration for the fluid passageways 222. The fluid passageways 222 may have any other desired geometry.

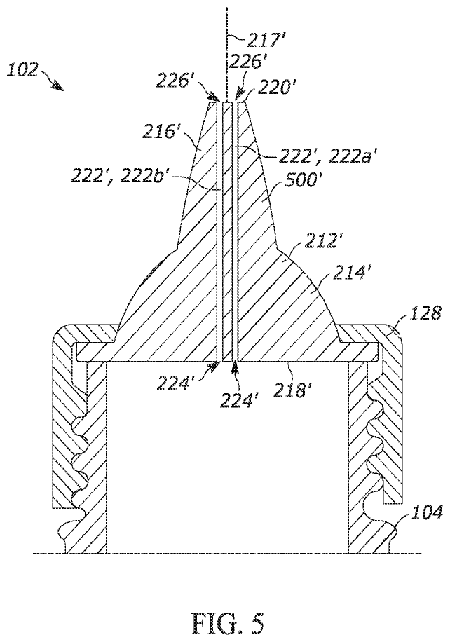

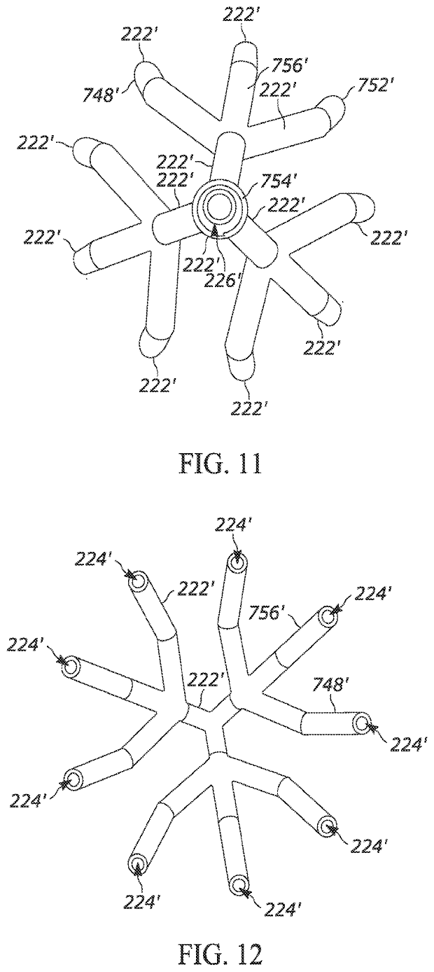

FIGS. 5, 6, 7-8, 10-14, and 15-16 illustrate other exemplary configurations of the artificial nipple 100 in FIGS. 1a-b that are designed in accordance with the present disclosure. The artificial nipples 500, 600, 700, 1000, 1500 of FIGS. 5, 6, 7-8, 10-14, and 15-16 are similar to the artificial nipple 200 of FIG. 2 and therefore, structures of FIGS. 5, 6, 7-8, 10-14, and 15-16 that are the same as or similar to those described with reference to FIG. 2 have the same reference numbers with the addition of a “prime” mark. Description of common elements and operation similar to those in the previously described configuration(s) may not be repeated with respect to the configurations of FIGS. 5, 6, 7-8, 10-14, and 15-16, but should instead be considered to be incorporated below by reference as appropriate. Furthermore, elements, functions, structures, material composition, and/or advantages shown or described with respect to one configuration may be shared by any other configuration whether expressly stated, shown, or not.

As shown in FIG. 5, the artificial nipple 500 may be configured such that each of the fluid passageways 222′ extends linearly in the longitudinal direction relative to the central longitudinal axis 217′ of the artificial nipple 500. However, instead of the lateral diameters of every fluid passageway 222′ being the same, the lateral diameter of at least one of the fluid passageways 222′ may be different (e.g., larger or smaller) than at least one of the other fluid passageways 222′. In the exemplary configuration of FIG. 5, the artificial nipple 500 includes at least one large lateral diameter fluid passageway 222′ (indicated at 222a′) and at least one small lateral diameter fluid passageway 222′ (indicated at 222b′). If desired, the artificial nipple 500 may be configured such that the lateral diameters of the fluid passageways 222′ are all different from one another, or such that the lateral diameter of only one of the fluid passageways 222′ is different from the other of the fluid passageways 222′.

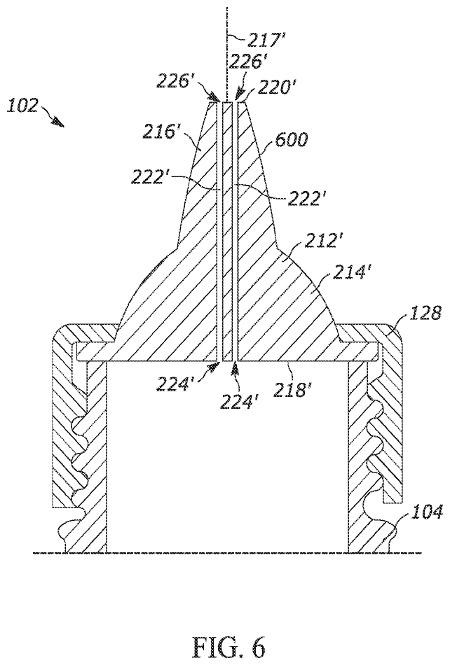

As shown in FIG. 6, the artificial nipple 600 may be configured such that at least one of the fluid passageways 222′, instead of extending linearly between the inlet and outlet openings 224′, 226′, may be tapered between the inlet and outlet openings 224′, 226′. For example, as shown in the exemplary configuration of the artificial nipple 600 of FIG. 6, each fluid passageway 222′ inwardly tapers from the inlet opening 224′ to the outlet opening 226′ as each fluid passageway 222′ extends in the longitudinal direction relative to the central longitudinal axis 217′ of the artificial nipple 600. In other words, the lateral diameters of the inlet openings 224′ are greater than the lateral diameters of the outlet openings 226′ so that the lateral diameters of the fluid passageways 222′ decrease as they extend longitudinally from inlet openings 224′ to the outlet openings 226′. Although the fluid passageways 222′ are shown as having the same lateral diameter as one another at each longitudinal position, the lateral diameter of at least one of the tapered fluid passageways 222′ may be larger or smaller than at least one other of the fluid passageways 222′ at each longitudinal position. Furthermore, although the fluid passageways 222′ of FIG. 6 are both shown as being tapered, the artificial nipple 100 may include at least one tapered fluid passageway 222 and at least one linear fluid passageway 222′.

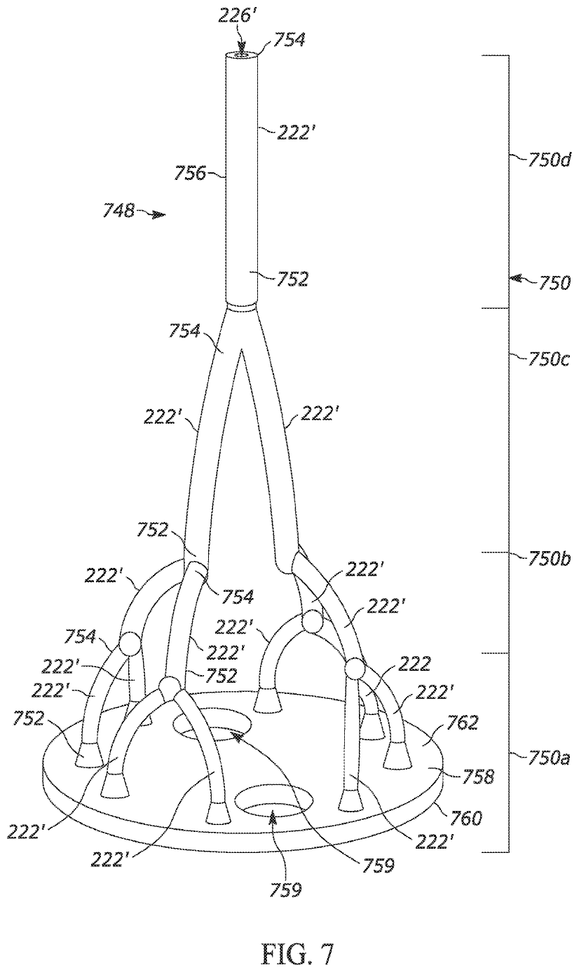

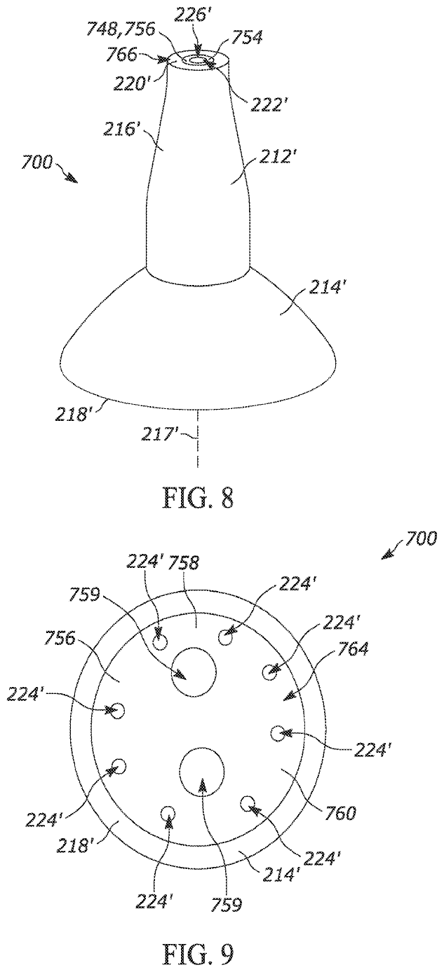

The artificial nipple 700 includes a network 748 and a nipple body 212′. As shown in FIGS. 7-8, the network 748 comprises the plurality of fluid passageways 222′ extending longitudinally (or “substantially” longitudinally when relatively minor deviations occur due to the geometry of the individual fluid passageways 222′) between a plurality of inlet openings 224′ and a single outlet opening 226′ relative to the central longitudinal axis 217′ of the artificial nipple 700. As used herein, the term “substantially longitudinal” means “longitudinal+/−10 degrees, preferably longitudinal+/−5 degrees, more preferably longitudinal+/−1 degree.” At least one of the passageways 222′ may be at least partially straight, bent, arcuate, or otherwise shaped in order to help achieve or to correspond to a desired nipple body 212′ shape. The network 748 includes a plurality of tiers 750 along a longitudinal length of the network 748 and, thus, the artificial nipple 700 as a whole. Each tier 750 includes at least one fluid passageway 222′ in direct fluid communication with at least two fluid passageways 222′ of another tier 750.

As shown in the exemplary configuration of FIG. 7, the tiers 750 may include four passageway tiers 750 (shown here as first through fourth tiers 750a-d). The first tier 750a has eight fluid passageways 222′. Each first tier fluid passageway 222′ has a first end 752 in fluid communication with an associated one of the inlet openings 224′ and a second end 754. The second tier 750b has four fluid passageways 222′. Each second tier fluid passageway 222′ has a first end 752 in fluid communication with the second ends 754 of two adjacent fluid passageways 222′ of the first tier 750a and a second end 754. The third tier 750c has two fluid passageways 222′. Each third tier fluid passageway 222′ has a first end 752 in fluid communication with the second ends 754 of two adjacent fluid passageways 222′ of the second tier 750b and a second end 754. The fourth tier 750d has one fluid passageway 222′. The fourth tier fluid passageway 222′ has a first end 752 in fluid communication with the second ends 754 of the fluid passageways 222′ of the third tier 750c and a second end 754 in fluid communication with the single outlet opening 226′. Therefore, the number of fluid passageways 222′ between two adjacent tiers 750 of the network 748 shown in FIG. 7 changes by a factor of two. However, the network 748 may have any number of fluid passageways 222′ in each tier as long as the network 748 extends from a plurality of inlet openings 224′ to a single outlet opening 226′.

The network 748 shown in FIG. 7 is defined by a network structure 756. As shown in FIG. 8, this network structure 756 is formed separately from the nipple body 212′ and subsequently at least partially encompassed by the nipple body 212′ to form the artificial nipple 700. For example, the nipple body 212′ may be overmolded onto the network structure 756.

As shown in FIG. 7, the network structure 756 may also include a base plate 758. The base plate 758 has longitudinally opposite proximal and distal plate surfaces 760, 762. The base plate 758 may have at least one alignment opening 759 (shown here as a plurality of alignment openings 759) extending longitudinally through the base plate 758 from the proximal plate surface 760 to the distal plate surface 762. The alignment openings may be used to orient the network structure 756 in a desired manner and maintain such desired orientation as the nipple body 212′ is over molded onto the network structure 756.

The fluid passageways 222′ extend longitudinally from the distal plate surface 762. As shown in FIG. 9, the proximal plate surface 760 may form a single, continuous proximal end surface 764 of the artificial nipple 700 with the proximal end surface 218′ of the nipple body 212′ when the network structure 756 is encompassed by the nipple body 212′. The inlet openings 224′ thus are adjacent the proximal end surface 218′ of the nipple body 212′, but extend longitudinally through the base plate 758 between the proximal and distal plate surfaces 760, 762. Alternatively, the proximal plate surface 760 may be encapsulated in the nipple body 212′ such that the proximal plate surface 760 is longitudinally offset from the proximal end surface 218′ of the nipple body 212′. In this offset configuration, the inlet openings 224′ are located at the proximal end surface 218′ and extend through both a portion of the nipple body 212′ and the base plate 758 to fluidically connect to the first ends 752 of a first tier fluid passageways 222′. The first tier 750 may be defined as the tier 750 of fluid passageways 222′ that is located closest to the inlet openings 224′ in the longitudinal direction. As another alternative, the base plate 758 of the network structure 756 may be omitted. In this base plate-free configuration, the first ends 752 of the first tier fluid passageways 222′ are in fluid communication with the inlet openings 224′ located at the proximal end surface 218′.

As shown in FIG. 8, the network structure 756 adjacent the second end(s) 754 of the fluid passageway(s) 222′ of a last tier 750 may form a single, continuous distal end surface 766 with the distal end surface 220′ of the nipple body 212′ when the network structure 756 is encompassed by the nipple body 212′. The last tier 750 may be defined as the tier 750 of fluid passageways 222′ that is located furthest from the inlet openings 224′ in the longitudinal direction. The outlet opening 226′ thus may be adjacent the distal end surface 220′ of the nipple body 212′, but formed by the network structure 756. Alternatively, the network structure 756 adjacent the second end(s) 754 of the fluid passageway(s) 222′ of the last tier 750 may be encapsulated in the nipple body 212′ and longitudinally offset from the distal end surface 220′ of the nipple body 212′. In this offset configuration, the outlet opening 226′ is located at the distal end surface 220′ and extends through a portion of the nipple body 212′ to fluidically connect to the second end(s) 754 of the last tier fluid passageway(s) 222′.

Instead of the network 748 being defined by the separate network structure 756, the nipple body 212′ may be formed having an interior geometry that defines network 748. The network 748 thus may be formed by selectively omitting portions of nipple body material in the interior of the nipple body 212′ and without the inclusion of a structure separate from the nipple body 212′. In this configuration, the fluid passageways 222′ of the network 748 extend between the inlet openings 224′ located at the proximal end surface 218′ of the nipple body 212′ and the single outlet opening 226′ located at the distal end surface 220′ of the nipple body 212′. This network structure-free artificial nipple 700 can be formed via injection molding, 3D printing, or in any other suitable manner.

Regardless of whether the network 748 is defined by the separate network structure 756 or the nipple body 212′ itself, the nipple body 212′ is substantially solid. By substantially solid it is meant that except for the inclusion of the network 748, the nipple body 212′ is solid from the proximal end surface 218′ to the distal end surface 220′. In other words, the nipple body 212′ has a volume that is entirely solid other than a volume defined by the network 748.

The artificial nipple 700 of FIGS. 7-8 may be secured and retained secured to the container 104 via the collar 128 and compressive force. In such case, the artificial nipple 700 may include the external flange (not shown in FIG. 7). The external flange of the artificial nipple 700 may be a partial or fully annular flange that extends laterally outward from the base portion 214′ of the nipple body 212′ and/or the base plate 758. However, the artificial nipple 700 may be secured and/or retained secured to the container 104 in any other desired manner. When the artificial nipple 700 is secured to the container 104, the inlet openings 224′ are axially aligned with the container opening 108 and fluidically connect the interior cavity 106 to the first tier fluid passageways 222′.

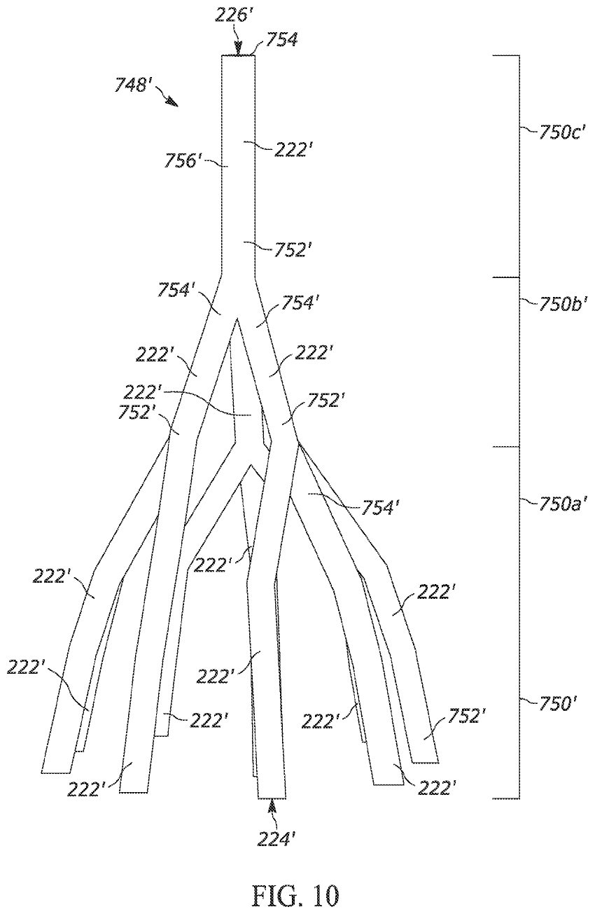

The artificial nipple 1000 similarly includes a network 748′ and a substantially solid nipple body 212′. As shown in FIGS. 10-14, the network 748′ comprises the plurality of fluid passageways 222′ extending substantially longitudinally between a plurality of inlet openings 224′ and a single outlet opening 226′ relative to the central longitudinal axis 217′ of the artificial nipple 1000. At least one of the passageways 222′ may be at least partially straight, bent, arcuate, or otherwise shaped in order to help achieve or to correspond to a desired nipple body 212′ shape. The network 748′ includes a plurality of tiers 750′ along a longitudinal length of the network 748′ and, thus, the artificial nipple 1000 as a whole. Each tier 750′ includes at least one fluid passageway 222′ in direct fluid communication with a plurality fluid passageways 222′ of another tier 750′.

As shown in the exemplary configuration of FIGS. 10-14, the tiers 750 may include three passageway tiers 750′ (shown here as first through third tiers 750a′, 750b′, 750c′). The first tier 750a′ has nine fluid passageways 222′. Each first tier fluid passageway 222′ has a first end 752′ in fluid communication with an associated one of the inlet openings 224′ and a second end 754′. The second tier 750b′ has three fluid passageways 222′. Each second tier fluid passageway 222′ has a first end 752′ in fluid communication with the second ends 754′ of three adjacent fluid passageways 222′ of the first tier 750a′ and a second end 754′. The third tier 750c′ has one fluid passageway 222′. The third tier fluid passageway 222′ has a first end 752′ in fluid communication with the second ends 754′ of the fluid passageways 222′ of the third tier 750c and a second end 754′ in fluid communication with the single outlet opening 226′. Therefore, the number of fluid passageways 222′ between two adjacent tiers 750′ of the network 748′ shown in FIGS. 10-14 changes by a factor of three. However, the network 748′ may have any number of fluid passageways 222′ in each tier as long as the network 748′ extends from a plurality of inlet openings 224′ to a single outlet opening 226′.

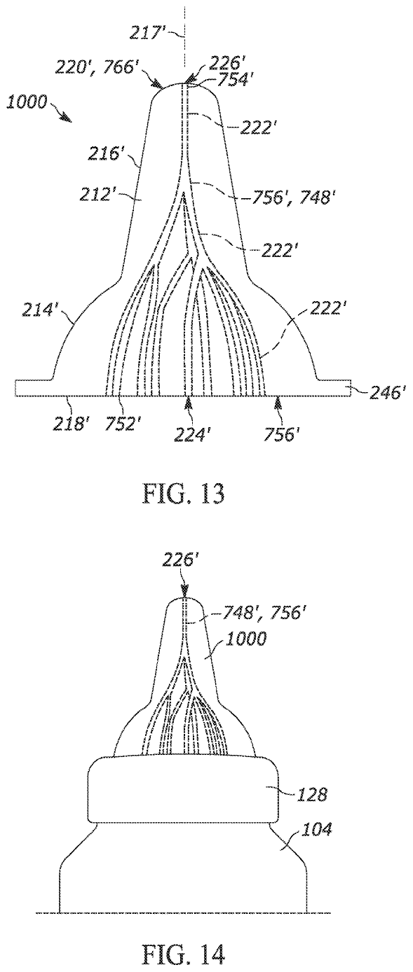

The network 748′ shown in FIGS. 10-14 is defined by a network structure 756′. As shown in FIGS. 13-14, this network structure 756 is formed separately from the nipple body 212′ and subsequently at least partially encompassed by the nipple body 212′ to form the artificial nipple 1000. For example, the nipple body 212′ may be overmolded onto the network structure 756′.

As shown in FIG. 13, the inlet openings 224′ are located at or adjacent to the proximal end surface 218′ of the nipple body 212′. For example, the network structure 756′ adjacent the first ends 752′ of the first tier fluid passageway(s) 222′ may form a single, continuous proximal end surface 764′ with the proximal end surface 218′ of the nipple body 212′ when the network structure 756′ is encompassed by the nipple body 212′. The inlet openings 224′ thus may be adjacent the proximal end surface 218′ of the nipple body 212′, but formed by the network structure 756′. Alternatively, the network structure 756′ adjacent the first ends 752′ of the first tier fluid passageway(s) 222′ may be encapsulated in the nipple body 212′ and longitudinally offset from the proximal end surface 218′ of the nipple body 212′. In this offset configuration, the outlet opening 226′ is located at the proximal end surface 218′ and extends through a portion of the nipple body 212′ to fluidically connect to the first ends 752′ of the first tier fluid passageway(s) 222′.

The network structure 756′ adjacent the second end(s) 754′ of the fluid passageway(s) 222′ of the last tier 750 may form a single, continuous distal end surface 766′ with the distal end surface 220′ of the nipple body 212′ when the network structure 756′ is encompassed by the nipple body 212′. The outlet opening 226′ thus may be adjacent the distal end surface 220′ of the nipple body 212′, but formed by the network structure 756′. Alternatively, the network structure 756′ adjacent the second end(s) 754′ of the fluid passageway(s) 222′ of the last tier 750′ may be encapsulated in the nipple body 212′ and longitudinally offset from the distal end surface 220′ of the nipple body 212′. In this offset configuration, the outlet opening 226′ is located at the distal end surface 220′ and extends through a portion of the nipple body 212′ to fluidically connect to the second end(s) 754′ of the last tier fluid passageway(s) 222′.

As shown in FIGS. 13-14, The artificial nipple 1000 may be secured and retained secured to the container 104 via the collar 128 and compressive force. In such case, the artificial nipple 1000 may include the external flange 246′ that extends laterally outward from the base portion 214′ of the nipple body 212′. However, the artificial nipple 1000 may be secured and/or retained secured to the container 104 in any other desired manner. When the artificial nipple 1000 is secured to the container 104, the inlet openings 224′ are axially aligned with the container opening 108 and fluidically connect the interior cavity 106 to the first tier fluid passageways 222′.

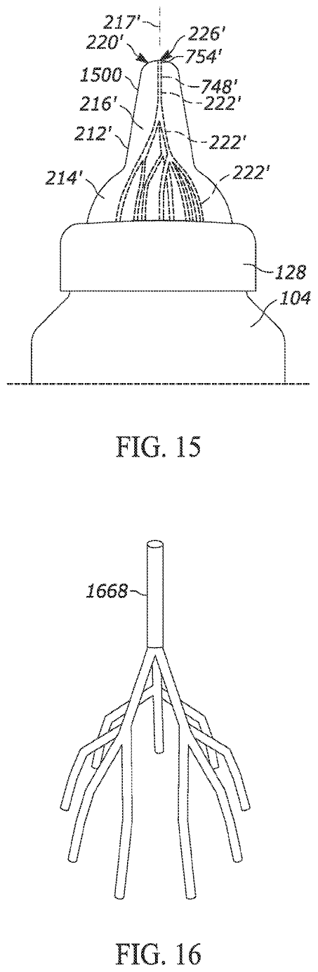

As shown in FIGS. 15-16, instead of the network 748′ being defined by the separate network structure 756′, the substantially solid nipple body 212′ may be formed having an interior geometry that defines network 748′. The network 748′ of the artificial nipple 1500 thus may be formed by selectively omitting portions of nipple body material in the interior of the nipple body 212′ and without a separate structure (e.g., the network structure 756′) that remains internal and/or external to the nipple body 212′ during use. However, when forming the artificial nipple 1500 of FIG. 15, the nipple body 212′ may be molded (e.g., overmolded) onto a pre-formed network molding structure 1668. FIG. 16 depicts an example of such a network molding structure 1668 (which, in this example configuration, is solid). The network 748 defined by the interior geometry of the nipple body 212′ thus is formed via the space occupied by the network molding structure 1668. The network molding structure 1668 is removed after the nipple body 212′ and its internal network 748′ are formed. The artificial nipple 1500 may be configured/packaged such that the removal may be completed via the manufacturer, the user, and/or any other third party. Furthermore, the artificial nipple 1500 can be formed via injection molding, 3D printing, or in any other suitable manner.

Although the artificial nipples 700, 1000, 1500 have been described and shown as having only one network 748, 748′, at least one of the artificial nipples 700, 1000, 1500 may have a plurality of networks 748, 748′. In a multi-network configuration, each network 748, 748′ may be at least partially encompassed by the nipple body 212′. Further, each network 748, 748′ comprises the plurality of the fluid passageways 222′ that extend between the plurality of inlet openings 224′ and the single outlet opening 226′ such that each network 748, 748′ has its own separate inlet openings 224′ and outlet opening 226′.

The outlet opening 226, 226′ of any of artificial nipples 100, 200, 500, 600, 700, 1000, 1500 may be made “center-cut” (so as to be or substantially be circular or otherwise rounded), or “cross-cut” (so as to be or substantially be in the shape of an “X” or a cross). A “cross-cut” outlet opening 226, 226′ may “open” open a predetermined amount of suction force is applied thereto.

### Exemplary Aspects

In view of the described devices, methods and variations thereof, herein below are certain more particularly described aspects of the present disclosure. These particularly recited aspects should not, however, be interpreted to have any limiting effect on any different claims containing different or more general teachings described herein, or that the “particular” aspects are somehow limited in some way other than the inherent meanings of the language literally used therein.

Aspect 1: An artificial nipple comprises a nipple body and a network. The nipple body has a base portion and a mouth portion extends longitudinally from the base portion. The nipple body has a proximal end surface at the base portion and an oppositely disposed distal end surface at the mouth portion. The network comprises a plurality of fluid passageways extending between a plurality of inlet openings located at or adjacent to the proximal end surface and a single outlet opening located at or adjacent to the distal end surface.

Aspect 2: The artificial nipple of Aspect 1, wherein the network includes a plurality of tiers along a longitudinal length of the artificial nipple. Each tier includes at least one fluid passageway in direct fluid communication with a plurality of fluid passageways of another tier.

Aspect 3: The artificial nipple of any of Aspects 1-2, wherein the network includes a plurality of tiers along a longitudinal length of the artificial nipple. Each tier includes at least one fluid passageway in direct fluid communication with three fluid passageways of another tier.

Aspect 4: The artificial nipple of any of Aspects 1-3, wherein the network includes a plurality of tiers along a longitudinal length of the artificial nipple. Each tier includes at least one fluid passageway in direct fluid communication with at least two fluid passageways of another tier.

Aspect 5: The artificial nipple of any of Aspects 1-4, wherein a number of fluid passageways between two adjacent tiers changes by a factor of two or three.

Aspect 6: The artificial nipple of any of Aspects 1-5, wherein the tiers include: a first tier having eight fluid passageways, each first tier fluid passageway having a first end in fluid communication with an associated one of the inlet openings and a second end; a second tier having four fluid passageways, each second tier fluid passageway having a first end in fluid communication with the second ends of two adjacent fluid passageways of the first tier and a second end; a third tier having two fluid passageways, each third tier fluid passageway having a first end in fluid communication with the second ends of two adjacent fluid passageways of the second tier and a second end; and a fourth tier having one fluid passageway, the fourth tier fluid passageway having a first end in fluid communication with the second ends of the fluid passageways of the third tier and a second end in fluid communication with the single outlet opening.

Aspect 7: The artificial nipple of any of any of Aspects 1-5, wherein the tiers include: a first tier having nine fluid passageways, each first tier fluid passageway having a first end in fluid communication with an associated one of the inlet openings and a second end; a second tier having three fluid passageways, each second tier fluid passageway having a first end in fluid communication with the second ends of three adjacent fluid passageways of the first tier and a second end; and a third tier having one fluid passageway, the third tier fluid passageway having a first end in fluid communication with the second ends of the fluid passageways of the second tier and a second end in fluid communication with the single outlet opening.

Aspect 8: The artificial nipple of any of Aspects 1-7, wherein the network is defined by a network structure that is formed separately from and at least partially encompassed by the nipple body.

Aspect 9: The artificial nipple of any of Aspects 1-8, wherein the nipple body is overmolded onto the network structure.

Aspect 10: The artificial nipple of any of Aspects 1-7, wherein the network is formed by omitting portions of nipple body material in an interior of the nipple body and without a separate structure that remains internal and/or external to the nipple body during use.

Aspect 11: The artificial nipple of any of Aspects 1-10, wherein except for the inclusion of the network, the nipple body is solid from the proximal end surface to the distal end surface.

Aspect 12: The artificial nipple of any of Aspects 1-11, wherein the nipple body has a volume that is entirely solid other than a volume defined by the network.

Aspect 13: The artificial nipple of Aspects 1-12, wherein the nipple body has an external flange.

Aspect 14: The artificial nipple of any of Aspects 1-13, wherein the external flange is a partial or fully annular flange that extends laterally outward from the base portion.

Aspect 15: The artificial nipple of any of Aspects 1-14, wherein first ends of the first tier fluid passageways are in fluid communication with the inlet openings located at the proximal end surface.

Aspect 16: The artificial nipple of any of Aspects 1-9 and 11-15, wherein the network structure adjacent the second end of the fluid passageway of a last tier of the fluid passageways forms a single, continuous distal end surface with the distal end surface of the nipple body when the network structure is encompassed by the nipple body.

Aspect 17: The artificial nipple of any of Aspects 1-7 and 10-15, wherein the substantially solid nipple body is formed having an interior geometry that defines network.

Aspect 18: The artificial nipple of any of Aspects 1-7 and 10-17, wherein the substantially solid nipple body is formed without a separate structure that remains internal and/or external to the nipple body during use.

Aspect 19: The artificial nipple of any of Aspects 1-7 and 10-18, wherein when forming the artificial nipple, the nipple body is molded onto a pre-formed network molding structure. The network defined by the interior geometry of the nipple body thus is formed via the space occupied by the network molding structure. The network molding structure is removed after the nipple body and its internal network are formed and prior to use.

Aspect 20: The artificial nipple of any of Aspects 1-19, wherein the artificial nipple comprises a plurality of networks. Each network comprises the plurality of the fluid passageways that extend between the plurality of inlet openings and the single outlet opening such that each network has its own separate inlet openings and outlet opening.

Aspect 21: The artificial nipple of any of Aspects 1-20, wherein each network is at least partially encompassed by the nipple body.

Aspect 22: The artificial nipple of any of Aspects 1-20, further comprising at least one additional network. The at least one additional being separate from (e.g., not in fluid and/or direct fluid communication with) the network. The at least one additional network comprises a plurality of additional fluid passageways extending between a plurality of additional inlet openings located at or adjacent to the proximal end surface and a single additional outlet opening located at or adjacent to the distal end surface.

Aspect 23: A nursing bottle, comprising a container and the artificial nipple of any of Aspects 1-22. The container has an interior cavity and a container opening in fluid communication with the interior cavity. The artificial nipple of any of Aspects 1-22 is secured to the container such that the inlet openings are axially aligned with the container opening and fluidically connect the interior cavity to the fluid passageways of the network.

Aspect 24: The nursing bottle of Aspect 23, further comprising a collar for securing the artificial nipple to the container.

Aspect 25: The nursing bottle of any of Aspects 23-24, wherein the collar includes internal threads configured to mate with external threads on an outer surface of the container to secure the collar to the container.

Aspect 26: The nursing bottle of any of Aspects 23-25, wherein when the artificial nipple is secured to the container, an external flange of the artificial nipple is positioned longitudinally between an internal flange of the collar and a rim of the container and retained in such position via a compressive force.

Aspect 27: An artificial nipple comprises a substantially solid nipple body and a plurality of fluid passageways. The nipple body has a base portion and a mouth portion extending longitudinally from the base portion. The nipple body has a proximal end surface at the base portion and an oppositely disposed distal end surface at the mouth portion. The plurality of fluid passageways each extending longitudinally from an inlet opening located at the proximal end surface to an outlet opening located at the distal end surface.

Aspect 28: The artificial nipple of Aspect 27, wherein except for the inclusion of the fluid passageways, the nipple body is solid from the proximal end surface to the distal end surface.

Aspect 29: The artificial nipple of any of Aspects 27-28, wherein the nipple body has a volume that is entirely solid other than a volume defined by each of the fluid passageways.

Aspect 30: The artificial nipple of any of Aspects 27-29, wherein the nipple body has an external flange.

Aspect 31: The artificial nipple of any of Aspects 27-30, wherein the external flange is a partial or fully annular flange that extends laterally outward from the base portion.

Aspect 32: The artificial nipple of any of Aspects 27-31, wherein the plurality of fluid passageways comprises at least two fluid passageways.

Aspect 33: The artificial nipple of any of Aspects 27-32, wherein the plurality of fluid passageways comprises three fluid passageways.

Aspect 34: The artificial nipple of any of Aspects 27-33, wherein each fluid passageway extends linearly in the longitudinal direction such that the lateral diameters of the inlet opening, the fluid passageway, and the outlet opening are all the same.

Aspect 35: The artificial nipple of any of Aspects 27-34, wherein the lateral diameter of each fluid passageway is the same as each of the other fluid passageways.

Aspect 36: The artificial nipple of any of Aspects 27-34, wherein the lateral diameter of at least one of the fluid passageways is different than at least one of the other fluid passageways.

Aspect 37: The artificial nipple of any of Aspects 27-33 and 35-36, wherein at least one of the fluid passageways is tapered between the inlet and outlet openings.

Aspect 38: The artificial nipple of any of Aspects 27-37, wherein the artificial nipple includes at least one tapered fluid passageway and at least one linear fluid passageway.

Aspect 39: The artificial nipple of any of Aspects 1-38, wherein the mouth portion is configured to be at least partially inserted into a subject's oral cavity.

Aspect 40: The artificial nipple of any of Aspects 1-39, wherein the base portion has a larger lateral diameter than the mouth portion.

Aspect 41: A nursing bottle, comprising a container and the artificial nipple of any of Aspects 27-40. The container has an interior cavity and a container opening in fluid communication with the interior cavity. The artificial nipple of any of Aspects 27-40 is secured to the container such that the inlet openings are axially aligned with the container opening and fluidically connect the interior cavity to the fluid passageways of the network.

Aspect 42: The nursing bottle of Aspect 41, further comprising a collar for securing the artificial nipple to the container.

Aspect 43: The nursing bottle of any of Aspects 41-42, wherein the collar includes internal threads configured to mate with external threads on an outer surface of the container to secure the collar to the container.

Aspect 44: The nursing bottle of any of Aspects 41-43, wherein when the artificial nipple is secured to the container, an external flange of the artificial nipple is positioned longitudinally between an internal flange of the collar and a rim of the container and retained in such position via a compressive force.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein.

In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures.

Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment.

Though certain components described herein are shown as having specific geometric shapes, all structures of this disclosure may have any suitable shapes, sizes, configurations, relative relationships, cross-sectional areas, or any other physical characteristics as desirable for a particular application.

Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims. All patents, patent applications, and publications cited herein are incorporated by reference in their entirety.

The following examples are for the purpose of illustration only and are not intended to limit the scope of the claims, which are appended hereto.

### Example 1

An experiment was performed in which the inventors used a validated animal model for infant feeding, pigs (German et al., Dysphagia. 2017; 32:73-7), to test the hypothesis that a solid, soft tissue nipple would impact feeding function in infants through ontogeny. An artificial nipple 100 the same as, or substantially similar to, the artificial nipple 500 of FIG. 5 was utilized in this experiment. Animal models are an essential tool for evaluating feeding function in infants, as they allow for increased control over experimental settings and a longitudinal study design. Furthermore, animal models allow for much greater spatial and temporal resolution data to be acquired than in human infants due to ethical considerations associated with radiation exposure during videofluoroscopic swallow studies.

Advantageously, the results of this experiment demonstrate the utility of a ducted, soft tissue bottle nipple for infant feeding. Infants fed on a ducted nipple exhibited several correlates with breastfeeding, including increased pressure generation when feeding. Being raised on a ducted nipple also resulted in decreased rates of aspiration, especially when feeding on a ducted nipple, which is critical, especially in the context of infants with feeding difficulties who are at risk for health impacts associated with aspiration such as aspiration pneumonia. The use of a ducted nipple has several other implications, including an increased ability to switch between bottle and breastfeeding for caretakers who otherwise might only be able to bottle feed. This in turn, provides bottle-fed infants with the physiologic benefits of breastfeeding.

### Methods

### Animal Housing and Care

We obtained infant pigs (Yorkshire/Landrace) at 48 hours of age (Shoup Investments LTD, Wooster, OH, USA). Infants were housed in the NEOMED Comparative medicine unit, and were trained to feed on infant milk replacer (Solustart Pig Milk Replacement, Land o'Lakes, Arden Mills, MN, USA). All care and procedures for infants were approved by NEOMED IACUC Protocl #19-03-222.

### Nipple and Experimental Design

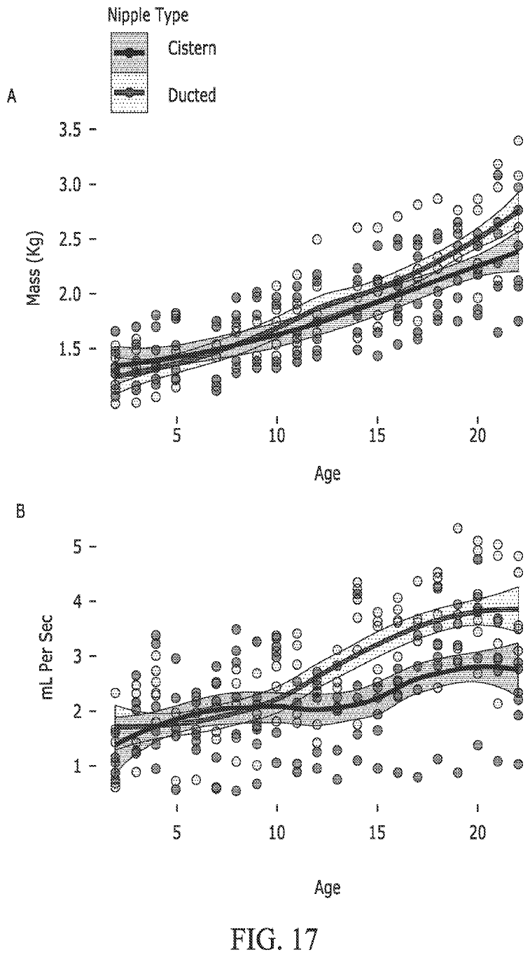

Infants were separated into two groups: one feeding on a standard, cisternic nipple (hereafter referred to as cisternic infants); and one feeding on a ducted nipple (hereafter referred to as ‘ducted infants’). Nipple size and shape was based off measurements taken from several nursing mothers, and both nipples had the same shape. We 3-D printed molds that were then used to cast nipples using silicone. We based the material properties of the nipples to approximate the durometer rating of breast tissue which is 00-10 (Briot et al. In vivo measurement of breast tissues stiffness using a light aspiration device. Clinical Biomechanics. 99, 105743 (2022); Ramião et al. Biomechanical properties of breast tissue, a state-of-the-art review. Biomech Model Mechanobiol 15, 1307-1323 (2016)). We achieved consistent results with silicone rubber of 00-20 (smooth-on Ecoflex 00-20). To ensure that variation in performance between infant groups, we measured the amount of force required to compress this nipple by 50%, and did the same for several nipples of different durometer ratings, with a 20A silicone nipple being most similar (smooth-on Dragonskin 20a). We also matched flow rate for both types of nipples both experimentally, and using Poiseuille's law. Thus, the only difference in design between nipples was whether one was ducted, or cisternic. The final ducted nipple was casted with three separate ducts, as many species of mammals have multiple openings at the nipple, with total flow being equal between nipples (FIG. 17).

Pigs were raised on their base-nipple for approximately 20 days (equivalent to an ~8 month infant). During this time, the total volume of milk per feed, as well as the duration of the feed was recorded for every feed, and was averaged for each day. We additionally recorded infant mass every day.

### Data Collection

At approximately 20 days of age, we recorded high-speed biplanar videofluoroscopy (GE 94000-Arm, 71-73 kV, 6.3-7.1 mA) with high speed cameras (XC1 M, XCitex, Cambridge, MA, USA) at 120 frames per second while pigs fed. Pigs were fed first on the nipple they were raised on, and then on the other nipple to document how they fed when exposed to a different nipple for the first time. We collected approximately 20 swallows per pig per condition. X-ray data were synchronized with intra-oral pressure generation using a 16 channel powerlab (16-35, ADInstruments, Colorado Springs, CO, USA) at 10 KHz.

### Data Processing

We identified suck timing from Xray video using standard procedures. We identified a total of 1165 sucks (Cisternic pigs on cisternic nipple N=309; Cisternic pigs on ducted nipple N=278; Ducted pigs on cisternic nipple N=307; ducted pigs on ducted nipple N=271). Sucks were identified as beginning on the frame at which the tongue made an anterior seal with the hard palate, and ending the frame before the next suck began. Instantaneous suck rate was calculated as 1 divided by the duration of the suck.

Swallows were identified as beginning on the frame at which the bolus was accumulated in the supraglottic space prior to passing the epiglottis, following standard procedures (Mayerl et al., Journal of Applied Physiology. 2019; 126:1681-6; Mayerl et al., Journal of Applied Physiology. 2020; 129:1383-92; Mayerl et al., Proc R Soc B. 2021; 288:20210052). In this, we recorded a total of 373 swallows (Cisternic pigs on cisternic nipple N=96; Cisternic pigs on ducted nipple N=95; Ducted pigs on cisternic nipple N=88; ducted pigs on ducted nipple N=94). Swallow rate was calculated as 1 divided by the time to the next suck (Mayerl et al., Proc R Soc B. 2021; 288:20210052), following standard procedures. We calculated sucks per swallow by documenting the number of sucks that contributed to each swallow. Bolus size was measured by calculating the surface area (in mm²) of the bolus at the initiation of the swallow using ImageJ. Volume of milk acquired per suck was calculated by dividing bolus size for a given swallow by the number of sucks it took to generate the bolus. We determined the frequency of penetration and aspiration using the Infant Mammalian Penetration Aspiration Scale (IMPAS), a scale equivalent to Penetration Aspiration Scale designed for adults.

Intraoral pressure was filtered with a 60 Hz low-pass filter to eliminate baseline electronic noise, downsampled by 83 (to 120 Hz to match framing rate) and exported from powerlab. Pressure generation data was loaded into a custom matlab routine along with data on suck and swallow timing. This matlab routine calculated the amount of pressure generated per suck, and per swallow in mmHg.

### Statistical Analyses

All statistical analyses were performed in R (v 4.3.0). We used linear mixed effects models (Bates, D., Mächler, M., Bolker, B., & Walker, S. (2015). Fitting Linear Mixed-Effects Models Using Ime4. Journal of Statistical Software, 67(1), 1-48) to test for differences in variables of interest, with the nipple an individual was raised on, the nipple an infant was feeding on, and their interaction as fixed effects, and individual infant as a random effect. Variables of interest include: Suck Rate, Swallow Rate, Pressure generated per suck, Bolus volume, feeding efficiency, and sucks per swallow. P values for main effects were obtained using the Anova( ) function on the model in R, and where interactions between effects were significant, we performed planned contrast analyses as well as Cohen's D (Cohen, J. (1992). A power primer. Psychological Bulletin, 112(1), 155-159).

To test for differences in swallow safety, we performed a logistic regression to evaluate differences across all four groups. We combined swallows with no penetration or penetration with clearance as being ‘safe’, for a total of three levels (safe, penetration without clearance, and aspiration). Logistic regression analyses calculated odds ratios for moving away from a safe swallow depending on group, and we also calculated p values using Wald-Chi-Squared Analyses (Mayerl et al., Journal of Applied Physiology. 2020; 129:1383-92).

### Results

### Ontogenetic Performance

We found that infants who were raised on a ducted nipple were marginally larger than those raised on a cisternic nipple, even though both groups were allowed to feed ad libidum, although differences by the end of infancy (~20 days) were not significant (F=2.6, p=0.13, cisternic mean=2.4±0.4 kg, ducted mean=2.8±0.4 kg). Furthermore, when evaluating feeding efficiency, we found that pigs raised on a ducted nipple were more efficient at feeding on that nipple within 15 days, a pattern that continued through infancy (day 20 means: cisternic mean=2.3±0.9 ml/s, ducted mean=3.2±0.5 ml/s, F=12.6, p=0.01.

### Behavioral Response to Nipple Design

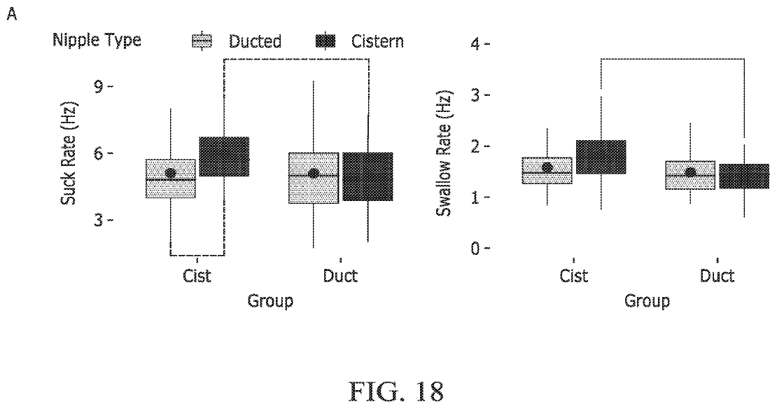

Overall, we found little variation in suck or swallow rate depending on what nipple pigs were raised on, or feeding on. Pigs raised on the ducted nipple did not differ substantially in suck or swallow rate when feeding on the ducted or cisternic nipple, and those feeding on the ducted nipple did not differ from cisternic pigs feeding on the ducted nipple for suck of swallow rate (p>0.05, small Cohen's D, Table 1, FIG. 18).

TABLE 1
Planned contrast and effect size (Cohen's D) results from statistical analyses (t, p; D)

| | Nipple effect | | Group effect | |
|---|---|---|---|---|
| | Raised on cist | Raised on duct | Feed on cist | Feed on duct |
| Suck Rate (Hz) | −5.8, <0.001; −0.67 | 0.62, 0.54; 0.05 | 8.01, <0.001; 0.75 | 0.16, 0.88; 0.02 |
| Swallow Rate | −3.7, <0.001; −0.45 | 1.2, 0.24; 0.25 | 5.9, <0.001; 0.8 | 1.2, 0.23; 0.2 |
| (Hz) | | | | |
| Pressure/suck | −5.2, <0.001; 0.48 | −2.3, 0.02; 0.8 | −1.7, 0.08; −0.14 | −8.8, <0.001; −0.85 |
| (mmHg) | | | | |
| Mm2/sec | −4.1, <0.001; −0.52 | 3.3, 0.001, 0.65 | 1.5, 0.14; 0.19 | −6.0, <0.001; −1.1 |
| Bolus size (mm²) | −2.6, 0.01; −0.33 | −3.9, <0.001; 0.66 | −2.3, 0.02; −0.32 | −8.9; <0.001; −1.4 |

Italicized values indicate statistically significant differences with medium effects size, bolded values indicate statistically significant differences with large effects sizes.

However, we did find that pigs raised on the cisternic nipple feeding on the cisternic nipple sucked at higher rates than when feeding on a ducted nipple (t=5.9, p<0.001, D=0.67), or compared to pigs raised on a ducted nipple feeding on a cisternic nipple (t=8.01, p<0.001, D=0.75). Cisternic pigs feeding on a cisternic nipple also swallowed at a higher rate than ducted pigs feeding on a cisternic nipple (t=5.8, p<0.-1, D=0.8), although they did not swallow at a statistically significantly faster rate than when feeding on a ducted nipple (t=3.7, p<0.001, D=0.45).

### Physiological Response to Nipple Design

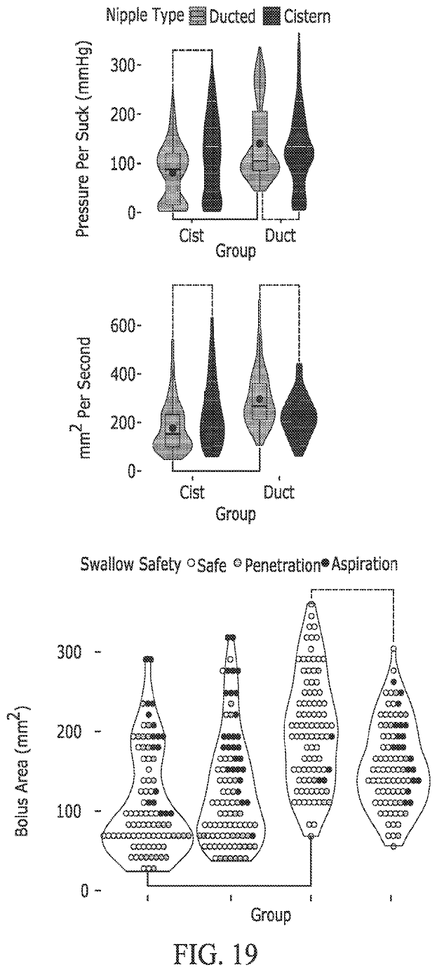

In contrast to the lack of response in behavioral rates, we found substantive differences in physiology depending on both the nipple an infant was raised on, and the nipple it fed on. This was especially prominent for pigs raised on a cisternic nipple feeding on a ducted nipple. These pigs generated less pressure per suck (t=−8.8 p<0.001, D=0.85), were less efficient at acquiring milk (t=−6.0, p<0.001, D=1.1) and had smaller boluses (t=−8.9, p<0.001, D=1.4) than pigs raised on a ducted nipple feeding on a ducted nipple (FIG. 19, Table 1, Table 2).

TABLE 2
Mean +/sd for variables of interest

| | Raised on cistern | | Raised on duct | |
|---|---|---|---|---|
| | Feed on Cist | Feed on Duct | Feed on Cist | Feed on Duct |
| Suck Rate (Hz) | 5.99 ± 1.25 | 5.10 ± 1.46 | 5.00 ± 1.37 | 5.08 ± 1.41 |
| Swallow Rate (Hz) | 1.88 ± 0.78 | 1.59 ± .46 | 1.39 ± 0.31 | 1.49 ± 0.46 |
| Pressure/suck | 113.6 ± 80.1 | 97.7 ± 58.4 | 124.4 ± 75.5 | 139.2 ± 79.3 |
| (mmHg) | | | | |
| % max pressure | 39.2 ± 0.27 | 25.9 ± 0.19 | 46.6 ± 0.26 | 52.6 ± 0.19 |
| mL/suck | 233.7 ± 153.8 | 225.1 ± 145.2 | 284.3 ± 126.7 | 389.1 ± 218.8 |
| Bolus size (cm²) | 667.3 ± 359.6 | 590.6 ± 326.1 | 843.3 ± 276.5 | 1058.8 ± 355.3 |

Pigs raised on a cisternic nipple also acquired less milk per suck and were less efficient at feeding when feeding on a ducted nipple compared to feeding on a cisternic nipple, although with medium effects size (FIG. 19, Table 1, Table 2). Infants raised on a ducted nipple feeding on a cisternic nipple had lower pressure generation, lower feeding efficiency, and smaller boluses than when feeding on a ducted nipple (Table 1, Table 2).

### Swallow Safety is Impacted by Nipple Design

Using pigs raised on a cisternic nipple feeding on a cisternic nipple as the baseline, we found that the probability of penetration and aspiration was impacted by what nipple an infant was feeding on, and to a lesser extent, what nipple an infant was raised on. Pigs raised on a ducted nipple, and feeding on a ducted nipple were associated with a decrease in the log odds of penetration by 2.18 (p<0.001) and a decrease in the log odds of aspiration by 2.6 (p<0.001) (Table 3). Pigs raised on a ducted nipple but feeding on a cisternic nipple were associated with a decrease in the log odds of penetration by 1.01 (p=0.01) and a decrease in the log odds of aspiration by 0.69 (p=0.05). For pigs feeding on a cisternic nipple, we observed no change in the log odds of penetration when feeding on a duct, but a decrease in the log odds of aspiration by 0.68, with marginal statistical significance (p=0.06).

TABLE 3
Results from logistic regression analyses, relative to an infant with a safe swallow
raised on a cisternic nipple feeding on a cisternic nipple (Log odds ± sd, p)

| | Raised Cist, feed duct | Raised Duct, feed Cist | Raised Duct, feed duct |
|---|---|---|---|
| Penetration | 0.01 ± 0.35, 0.97 | −1.01 ± 0.42, 0.01 | −2.18 ± 0.52, <0.001 |
| Aspiration | −0.68 ± 0.37, 0.06 | −0.69 ± 0.36, 0.05 | −2.6 ± 0.56, <0.001 |

Bolded values indicate a log odds of increased swallow safety with statistical significance; italicized values indicate a log odds of increased swallow safety with marginal statistical significance.

### Example 2

An experiment was performed in which the inventors used a validated animal model for infant feeding, pigs (German et al., Dysphagia. 2017; 32:73-7), to test the hypothesis that a solid, soft tissue nipple would impact feeding function in infants through ontogeny. An artificial nipple 100 the same as, or substantially similar to, the artificial nipple of FIG. 13 was utilized in this experiment. Animal models are an essential tool for evaluating feeding function in infants, as they allow for increased control over experimental settings and a longitudinal study design. Furthermore, animal models allow for much greater spatial and temporal resolution data to be acquired than in human infants due to ethical considerations associated with radiation exposure during videofluoroscopic swallow studies.

### Methods

### Animal Housing and Care

We obtained infant pigs (Yorkshire/Landrace) at 24 hours of age (Premier BioSource, CA, USA). Infants were housed in the NAU Comparative medicine unit, and were trained to feed on infant milk replacer (Birthright, Ralco Show, Marshall, MN, USA). All care and procedures for infants were approved by NAU IACUC Protocol #10-2022.

### Nipple and Experimental Design

Infants were separated into two groups: one feeding on a standard, cisternic nipple (hereafter referred to as cisternic infants); and one feeding on a ducted nipple (hereafter referred to as ‘ducted infants’). Nipple size and shape was based off measurements taken from several nursing mothers, and both nipples had the same shape. We 3-D printed molds that were then used to cast nipples using silicone. We based the material properties of the nipples to approximate the durometer rating of breast tissue which is 00-10 (Briot et al. In vivo measurement of breast tissues stiffness using a light aspiration device. Clinical Biomechanics. 99, 105743 (2022); Ramião et al. Biomechanical properties of breast tissue, a state-of-the-art review. Biomech Model Mechanobiol 15, 1307-1323 (2016)). We achieved consistent results with silicone rubber of 00-10 (smooth-on Ecoflex 00-10). To ensure that variation in performance between infant groups, we measured the amount of force required to compress this nipple by 50%, and did the same for several nipples of different durometer ratings, with a 20A silicone nipple being most similar (smooth-on Dragonskin 20a). We also matched flow rate for both types of nipples both experimentally, and using Poiseuille's law. Thus, the only difference in design between nipples was whether one was ducted, or cisternic. The final ducted nipple was casted with three separate ducts, as many species of mammals have multiple openings at the nipple, with total flow being equal between nipples.

Pigs were raised on their base-nipple for approximately 28 days (equivalent to a 10 month infant). During this time, the total volume of milk per feed, as well as the duration of the feed was recorded for every feed, and was averaged for each day. In this experiment we matched the volume across groups. We additionally recorded infant mass every day.

### Data Collection

At approximately 28 days of age, we recorded high-speed videofluoroscopy (GE 94000-Arm, 71-73 kV, 6.3-7.1 mA) with high speed cameras (Redwood, IO Industries, Ontario, Canada) at 100 frames per second while pigs fed. Pigs were fed first on the nipple they were raised on, and then on the other nipple to document how they fed when exposed to a different nipple for the first time. We collected approximately 20 swallows per pig per condition. X-ray data were synchronized with intra-oral pressure generation using a 16 channel powerlab (16-35, ADInstruments, Colorado Springs, CO, USA) at 10 KHz.

### Data Processing

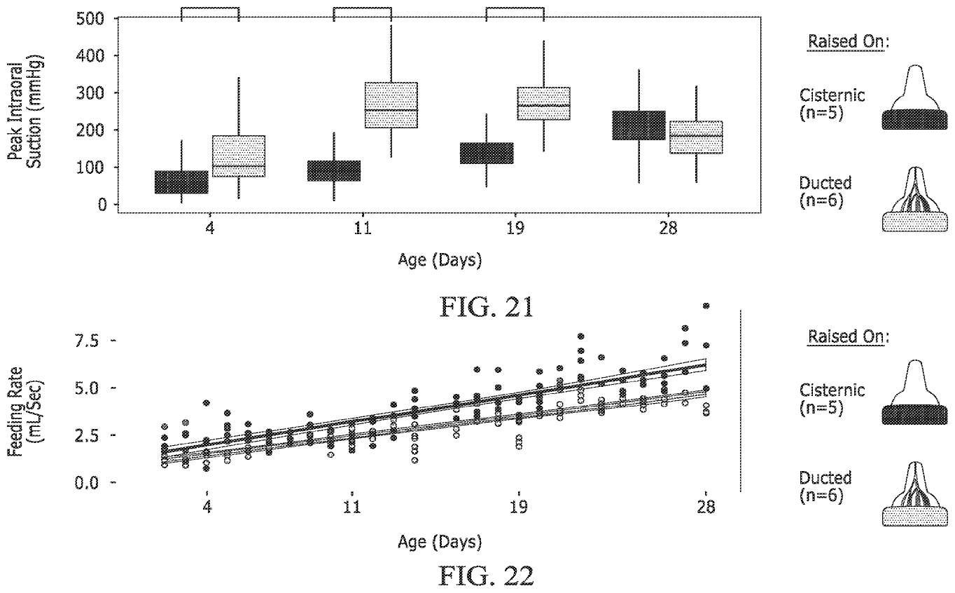

We identified suck timing from Xray video using standard procedures. We identified a total of 833 sucks (Cisternic pigs on cisternic nipple N=203; Cisternic pigs on ducted nipple N=235; Ducted pigs on cisternic nipple N=203; ducted pigs on ducted nipple N=192). Sucks were identified as beginning on the frame at which the tongue made an anterior seal with the hard palate, and ending the frame before the next suck began. Instantaneous suck rate was calculated as 1 divided by the duration of the suck. Data processing for ontogenetic data presented in FIG. 21 was accomplished by identifying a suck as the time between peak generation in a pressure wave and isolating that wave to acquire per-suck data. We identified 663, 458, and 482 sucks for ducted pigs on day 4, 11 and 19 respectively, and 356, 499 and 451 sucks for cisternic pigs on day 4, 11 and 19 respectively, with day 28 data being the same as above.

Swallows were identified as beginning on the frame at which the bolus was accumulated in the supraglottic space prior to passing the epiglottis, following standard procedures (Mayerl et al., Journal of Applied Physiology. 2019; 126:1681-6; Mayerl et al., Journal of Applied Physiology. 2020; 129:1383-92; Mayerl et al., Proc R Soc B. 2021; 288:20210052). In this, we recorded a total of 343 swallows (Cisternic pigs on cisternic nipple N=80; Cisternic pigs on ducted nipple N=89; Ducted pigs on cisternic nipple N=87; ducted pigs on ducted nipple N=986). Swallow rate was calculated as 1 divided by the time to the next suck (Mayerl et al., Proc R Soc B. 2021; 288:20210052), following standard procedures. We calculated sucks per swallow by documenting the number of sucks that contributed to each swallow. Bolus size was measured by calculating the surface area (in mm²) of the bolus at the initiation of the swallow using ImageJ. Volume of milk acquired per suck was calculated by dividing bolus size for a given swallow by the number of sucks it took to generate the bolus.

Intraoral pressure was filtered with a 60 Hz low-pass filter to eliminate baseline electronic noise, integrated to match the 100 fps video framing rate and exported from powerlab. Pressure generation data was loaded into a custom matlab routine along with data on suck and swallow timing. This matlab routine calculated the amount of pressure generated per suck, and per swallow in mmHg.

### Statistical Analyses

All statistical analyses were performed in R (v 4.3.0). We used linear mixed effects models (Bates, D., Mächler, M., Bolker, B., & Walker, S. (2015). Fitting Linear Mixed-Effects Models Using Ime4. Journal of Statistical Software, 67(1), 1-48) to test for differences in variables of interest, with the nipple an individual was raised on, the nipple an infant was feeding on, and their interaction as fixed effects, and individual infant as a random effect. Variables of interest include: Pressure generated per suck, Bolus volume, feeding efficiency, and tongue kinematics. P values for main effects were obtained using the Anova( ) function on the model in R, and where interactions between effects were significant, we performed planned contrast analyses as well as Cohen's D (Cohen, J. (1992). A power primer. Psychological Bulletin, 112(1), 155-159).

### Results

### Pigs Raised on Ducted Nipples of the Present Disclosure Learn to Latch Sooner.

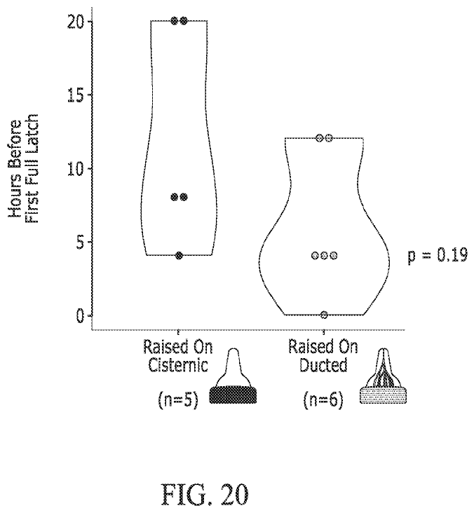

As shown in FIG. 20, pigs raised on cisternic nipples (blue) performed a full latch later than pigs raised on ducted nipples (green) of the present disclosure.

### Pigs Raised on Cisternic Nipples of the Present Disclosure Generate Less Suction Through Ontogeny.

As shown in FIG. 21, pigs raised on cisternic nipples (blue) generated less intraoral suction than pigs raised on ducted nipples (green) of the present disclosure throughout ontogeny (p<0.0001; cohen's d>1). Pigs raised on the ducted nipples achieved greater intraoral suction earlier in ontogeny than pigs raised on cisternic nipples. At 28 days old, both groups of pigs generated similar intraoral suction.

### Pigs Raised on Cisternic Nipples Consume Milk Faster

As shown in FIG. 22, pigs raised on cisternic nipples (blue) consumed milk faster than pigs raised on ducted nipples (green) of the present disclosure throughout ontogeny (p<0.005). And pigs raised on cisternic nipples (blue) increased their feeding rate through ontogeny faster than pigs raised on ducted nipples (green) (p<0.0001). Previous research has shown that faster milk consumption is correlated with a higher frequency of aspiration. These data parallel data on differences between bottle feeding and breastfeeding, as breastfeeding occurs at a lower rate than traditional bottle feeding.

### Pigs Raised on Cisternic Nipples Rely More on Expression of Milk

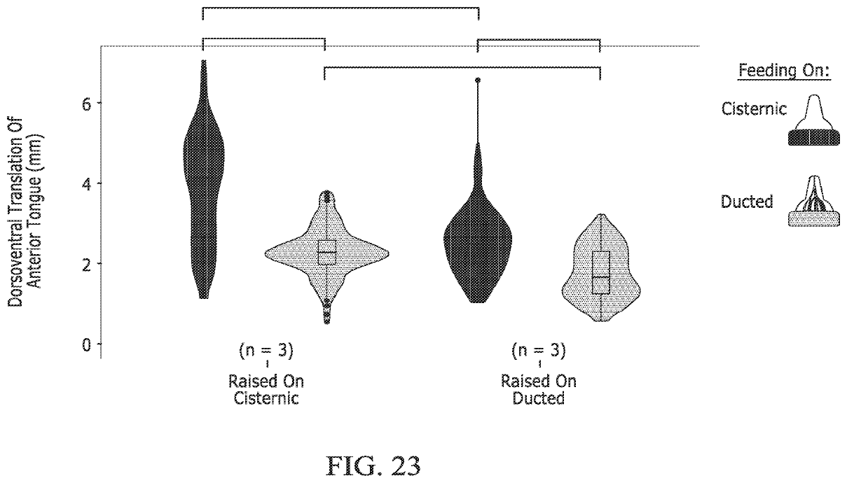

As shown in FIG. 23, at 28 days old, pigs feeding on cisternic nipples (blue) compressed the nipple (i.e., moved their tongue and jaw up and down) more than pigs feeding on ducted nipples (green) of the present disclosure (p<000.1, cohen's d>1). In addition, pigs raised on cisternic nipples (left) compressed the nipple more than pigs raised on ducted nipples (right) (p<000.1, cohen's d>0.8). Compressing the nipple causes milk to be expressed. This provides an explanation for why pigs raised on cisternic nipples had higher feeding rates than pigs raised on ducted nipples.

### Pigs Generate Similar Intraoral Suction on Both Nipple Types

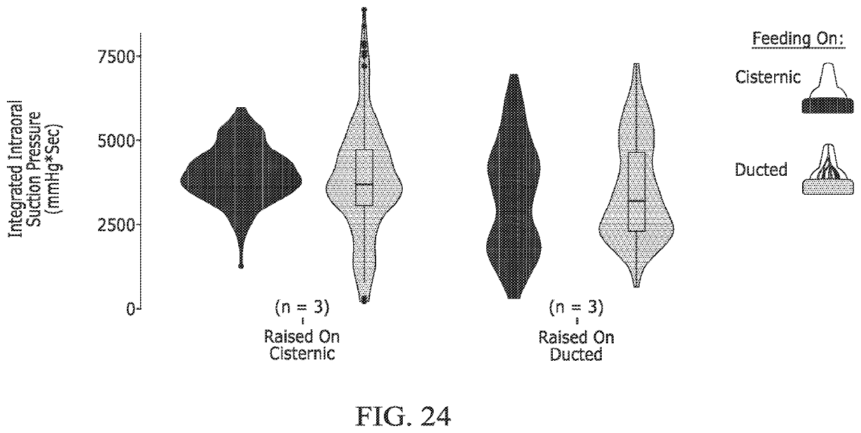

As shown in FIG. 24, at 28 days old, all pigs generated intraoral suction (p>0.05) regardless of the nipple type they were raised on or feeding on.

### Pigs Feed Faster on Cisternic Nipples (and Especially if Raised on Cisternic Nipples)

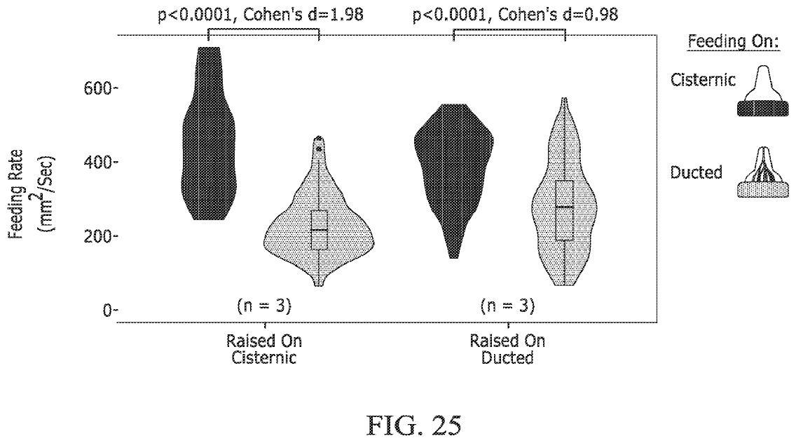

As shown in FIG. 25, at 28 days old, pigs feeding on cisternic nipples (blue) consumed milk faster than pigs feeding on ducted nipples (green) of the present disclosure (p<0.0001, cohen's d>0.9). This difference was especially true for pigs raised on cisternic nipples (which had twice the effect size compared to pigs raised on ducted nipples).

Together, the results of FIG. 21-25 indicate that infants raised on a cisternic nipple use a combination of suction and nipple compression (resulting in expression) when feeding, whereas being raised on a ducted nipple results in only suction being used to acquire milk, which parallels differences between breastfeeding (a suction based mechanism) and traditional bottle feeding (which can occur through a combination of suction and expression).

The following is claimed:

1. An artificial nipple, comprising:
a nipple body having a base portion and a mouth portion extending longitudinally from the base portion, the nipple body having a proximal end surface at the base portion and an oppositely disposed distal end surface at the mouth portion; and
a network comprising a plurality of fluid passageways extending between a plurality of inlet openings located at or adjacent to the proximal end surface and a single outlet opening located at or adjacent to the distal end surface.

2. The artificial nipple of claim 1, wherein the network includes a plurality of tiers along a longitudinal length of the artificial nipple, each tier includes at least one fluid passageway in direct fluid communication with at least two fluid passageways of another tier.

3. The artificial nipple of claim 2, wherein a number of fluid passageways between two adjacent tiers changes by a factor of two or three.

4. The artificial nipple of claim 2, wherein the tiers include:
a first tier having eight fluid passageways, each first tier fluid passageway having a first end in fluid communication with an associated one of the inlet openings and a second end;
a second tier having four fluid passageways, each second tier fluid passageway having a first end in fluid communication with the second ends of two adjacent fluid passageways of the first tier and a second end;
a third tier having two fluid passageways, each third tier fluid passageway having a first end in fluid communication with the second ends of two adjacent fluid passageways of the second tier and a second end; and
a fourth tier having one fluid passageway, the fourth tier fluid passageway having a first end in fluid communication with the second ends of the fluid passageways of the third tier and a second end in fluid communication with the single outlet opening.

5. The artificial nipple of claim 2, wherein the tiers include:
a first tier having nine fluid passageways, each first tier fluid passageway having a first end in fluid communication with an associated one of the inlet openings and a second end;
a second tier having three fluid passageways, each second tier fluid passageway having a first end in fluid communication with the second ends of three adjacent fluid passageways of the first tier and a second end; and
a third tier having one fluid passageway, the third tier fluid passageway having a first end in fluid communication with the second ends of the fluid passageways of the second tier and a second end in fluid communication with the single outlet opening.

6. The artificial nipple of claim 1, wherein the network is defined by a network structure that is formed separately from and at least partially encompassed by the nipple body.

7. The artificial nipple of claim 6, wherein the nipple body is overmolded onto the network structure.

8. The artificial nipple of claim 1, wherein the network is formed by omitting portions of nipple body material in an interior of the nipple body and without a separate structure that remains internal and/or external to the nipple body during use.

9. The artificial nipple of claim 1, wherein except for the inclusion of the network, the nipple body is solid from the proximal end surface to the distal end surface.

10. The artificial nipple of claim 1, wherein the nipple body has a volume that is entirely solid other than a volume defined by the network.

11. A nursing bottle, comprising:
a container having an interior cavity and a container opening in fluid communication with the interior cavity; and
the artificial nipple of claim 1 secured to the container such that the inlet openings are axially aligned with the container opening and fluidically connect the interior cavity to the fluid passageways of the network.

12. The nursing bottle of claim 11, further comprising a collar for securing the artificial nipple to the container.

13. The nursing bottle of claim 12, wherein the collar includes internal threads configured to mate with external threads on an outer surface of the container to secure the collar to the container.

14. The nursing bottle of claim 13, wherein when the artificial nipple is secured to the container, an external flange of the artificial nipple is positioned longitudinally between an internal flange of the collar and a rim of the container and retained in such position via a compressive force.

15. An artificial nipple, comprising:
a substantially solid nipple body having a base portion and a mouth portion extending longitudinally from the base portion, the nipple body having a proximal end surface at the base portion and an oppositely disposed distal end surface at the mouth portion; and
a plurality of fluid passageways each extending longitudinally from an inlet opening located at the proximal end surface to an outlet opening located at the distal end surface.

16. The artificial nipple of claim 15, wherein except for the inclusion of the fluid passageways, the nipple body is solid from the proximal end surface to the distal end surface.

17. The artificial nipple of claim 15, wherein the nipple body has a volume that is entirely solid other than a volume defined by each of the fluid passageways.

18. A nursing bottle, comprising:
a container having an interior cavity and a container opening in fluid communication with the interior cavity; and
the artificial nipple of claim 15 secured to the container such that the inlet openings are axially aligned with the container opening and fluidically connect the interior cavity to the fluid passageways.

19. The nursing bottle of claim 18, further comprising a collar for securing the artificial nipple to the container.

20. The nursing bottle of claim 19, wherein when the artificial nipple is secured to the container, an external flange of the artificial nipple is positioned longitudinally between an internal flange of the collar and a rim of the container and retained in such position via a compressive force.
